(19) United States
(12) Patent Application Publication
(10) Pub. No.: US 2021/0070479 A1
(43) Pub. Date: Mar. 11, 2021

(54) Space force engine

(71) Applicant: Michael Joseph Carew, Franklin, NJ (US)

(72) Inventor: Michael Joseph Carew, Franklin, NJ (US)

(21) Appl. No.: 16/974,208

(22) Filed: Nov. 14, 2020

(51) Int. Cl. B64G 1/40

(52) U.S. Cl. CPC B64G 1/409

(57) ABSTRACT

This Space Force Engine is designed for use in deep space. The Space Force engine uses Newton's third law of motion that for every ‘action’ there is an ‘equal and opposite’ reaction. An ironless Lorentz type tubular linear motor, de-acceleration and acceleration the movable rod, produces a forward force the de-acceleration and acceleration of the movable rod in the opposite direction produces a backward force.

The linear centripetal forces, created by an Angular Momentum Engine counteract the backward reaction force and thereby results in a net forward acceleration to the space vehicle by the forward force.

### BACKGROUND

The dimensions of space and time, a daunting image, undefined in its breath and depth, are by some estimates some 7 trillion billion light years of space and time. Space is our future and only future as our every day resources that supply our very existence, food, water, energy, and industrial resources, are rapidly being depleted, aggravated by global warming, threatens our ability as industrialized nations to produce and maintain the new industrial revolutions that will change the face of its nations.

Space offers new challenges in propulsion for theoretical models to offer potential warp drive speeds for space and time travel. It is such a model that is illustrated in this patent application.

### BRIEF DESCRIPTION OF THE DRAWINGS

FIG. 1—Space Force Engine propulsion calculations—per engine

FIG. 2—Space Force Engine system design

FIG. 3a—Propulsion cycles—forward force and backward force

FIG. 3b—Propulsion cycles—forward force and backward force—time/distance

FIG. 4—Linear centripetal force counteracts backward force

FIG. 5—Lorentz type Tubular linear motor design

FIG. 6—Motion Control System design

FIG. 7—System design—1 stage planetary gearbox (front view)

FIG. 7a—System design—1 stage planetary gearbox (top view)

FIG. 7b—System design—1 stage planetary gearbox (bottom view)

FIG. 8—System design—Angular Momentum Engine (front view)

FIG. 8.2—Reversing sprockets

FIG. 8.3—Timing Marks

FIGS. 9a—101 Planetary gearbox 1—top view (clockwise rotation)

FIGS. 9b—101 Planetary gearbox 1—top view (clockwise rotation)

FIGS. 9c—102 Planetary gearbox 2—top view (counter-clockwise rotation)

FIGS. 9d—102 Planetary gearbox 2—top view (counter-clockwise rotation)

FIG. 10-1—Pinion Gear—2×2 inch gear

FIG. 10-2—Planet Gear—4×2 inch gear

FIG. 10-3—Sun Gear—4×2 inch gear

FIG. 11—Space Force Engine compared to other propulsion systems

FIG. 12a—Planetary gearbox 1—top view (clockwise rotation)

FIG. 12b—Planetary gearbox 2—top view (counter-clockwise rotation)

### BRIEF DESCRIPTION OF THE INVENTION

This Space Force Engine is designed for use in deep space.

This Space Force Engine uses Newton's third law of motion that for every ‘action’ there is an ‘equal and opposite’ reaction.

This Space Force Engine has two components a Tubular Linear Motor that produces a forward and backward accelerating force and an Angular Momentum Engine that counteracts the backward force with its linear centripetal force.

This Space Force Engine design uses several basic fundamentals of motion: kinetic energy: the energy that an object possesses by virtue of being in motion, power: the rate of energy flow, acceleration/de-acceleration: the rate of change of the velocity of an object with respect to time, centripetal force: a force that is always acting inward as the velocity of the object is directed tangent to the circle, and last motion control: of the ironless tubular linear motor and angular momentum engine.

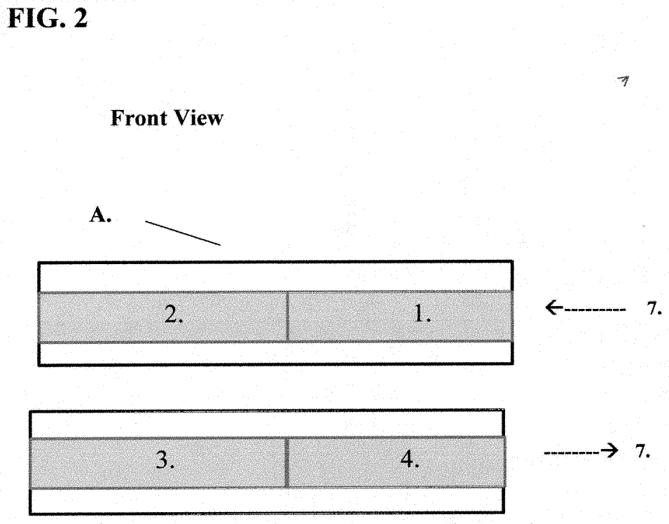

The A. ‘ironless Tubular Linear Motor’ simply 1. ‘accelerates’ and then 2. ‘de-accelerates’ the 7. ‘rod’ in one direction and then 3. ‘accelerates’ and 4. ‘de-accelerates’ the 7. ‘rod’ in the opposite direction. FIG. 2

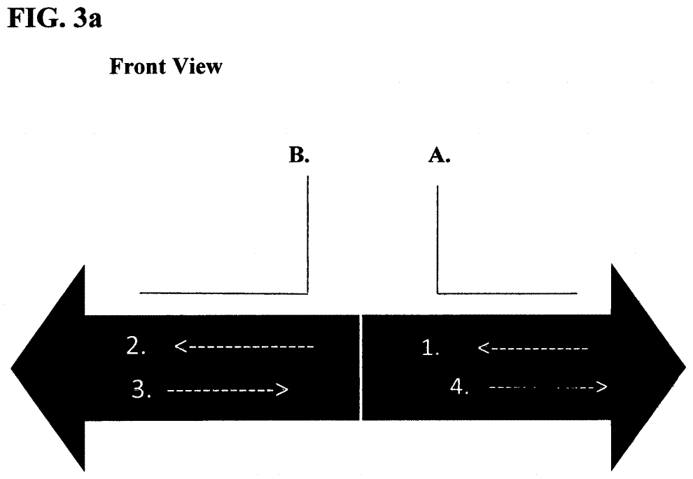

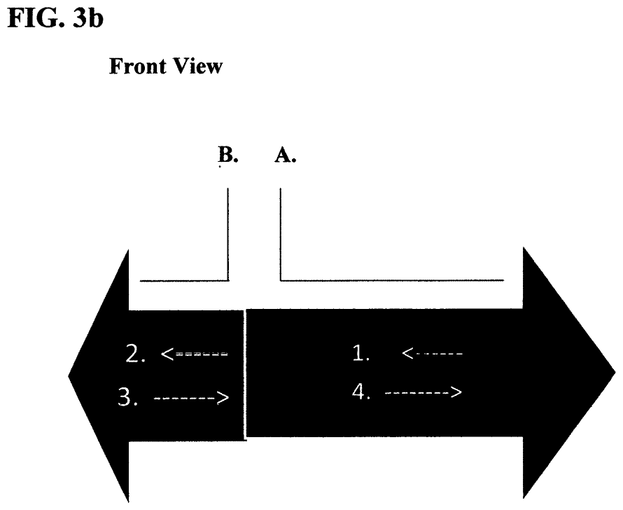

The ‘equal and opposite’ reaction from the 4. ‘de-acceleration’ and 1. ‘acceleration’ of the rod results in A. ‘forward force’. FIG. 3a

The ‘equal and opposite’ reaction from the 2. ‘de-acceleration’ and 3. ‘acceleration’ of the rod, in the opposite direction, results in a B. ‘backward force’. FIG. 3a

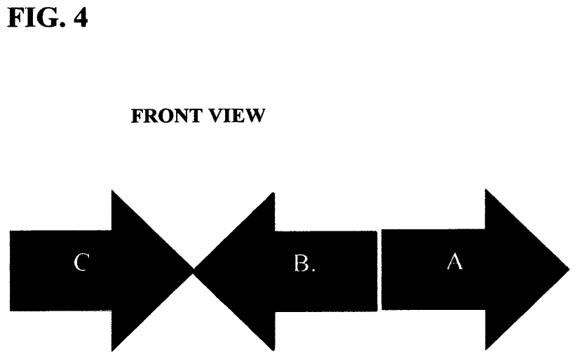

The linear centripetal forces of a C. ‘Angular Momentum Engine’ counteracts the B. ‘Tubular Linear Motors backward force’. The A. ‘Tubular linear Motors forward force’ then accelerates the space vehicle FIG. 4

The A. ‘Tubular linear Motors forward force’ and B. ‘Tubular Linear Motors backward force’ time and distance can vary to maximize its forward force over its backward force when the time is faster and distance shorter to 2. ‘de-acceleration’ and 3. ‘acceleration’ the rod in the B. ‘Tubular Linear Motors backward force’ than the 4. ‘de-acceleration’ and 1. ‘acceleration’ of the rod in the A. ‘Tubular linear Motors forward force’. FIG. 3b

One of the major issues confronting space flight is the type of fuel necessary for extended space travel.

KILOPOWER is an experimental project (NASA) aimed at producing new nuclear reactors for space travel. The electric power generated by this nuclear reactor is 1 to 10 kilowatts and the thermal power is 4.3 to 43.3 kilowatts per nuclear reactor.

Solar energy is another choice in the dynamics of space flight as an energy resource.

### DETAILED DESCRIPTION

It should be noted at this point that the Tubular Linear Motor, amplifiers (drives) and motion controllers used in this patent application are custom ‘off the shelf’ products. These products incorporated with the ‘Angular Momentum Engine’ are used in the design of this Space Force Engine.

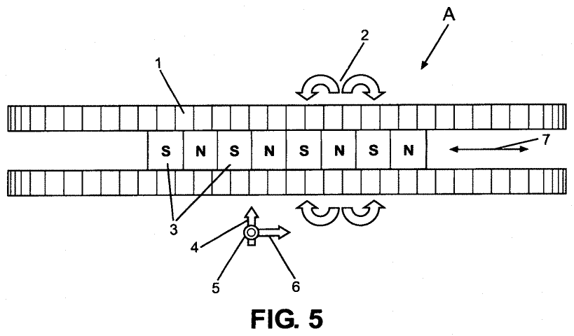

‘The A. ‘Tubular Linear Motor’ is a type of linear electric motor with 1. ‘windings’ consisting of a series of solenoids wrapped around a cylinder enclosing a movable 7. ‘rod’ that contain a number of strong cylindrical 3. ‘permanent magnets’ aligned in alternating and opposite directions.’ FIG. 5

‘The primary benefits of tubular linear motors over flat and U-channel types is their high efficiency.’

‘Linear motors work on the principal of the Lorentz Force, which states when a 1. ‘windings’ (conductor) with 5. ‘current’ (the stator) is placed in a 3. ‘magnetic field’ that is perpendicular to the 5. ‘current’, a force is generated on the 1. ‘windings’ (conductor). The direction of the 6. ‘thrust force’ is perpendicular to both the 4. ‘magnetic flux’ and the 5. ‘current’. FIG. 5 (Danielle Collins—gantry applications)

‘The key for tubular linear motors is that their design allows the entire 1. ‘windings’ (coil), not just a portion of the coil as in flat and U-channel designs, to be perpendicular to the magnetic flux, so all the 5. current is used to generate force in the 7. ‘rod's direction of travel, maximizing their efficiency.’ FIG. 5

‘This type of operation is a Lorentz-type actuator, in which the applied force is linearly proportional to the ‘current’ and the ‘magnetic field’ (F=qE+qV*B)’ FIG. 5

‘All motors have two critical components, the primary and the secondary. The primary is made of 1. ‘windings’ (copper coils) in which the 5. ‘current’ is applied to create an electromagnetic force. The number and length of the 1. ‘windings’ (copper coils) determines the motors force.’ FIG. 5

‘The secondary is the components that react to the electromagnetic force the 7. ‘rod’, and is made up of a series of 3. ‘permanent magnets’. In this tubular motor the primary is stationary, the secondary is the moving element.’ FIG. 5

‘Since an iron core adds to the magnetic attraction, iron core motors typically produce higher overall force, speed, and acceleration. However, the magnetic attraction between the iron core and the permanent magnets creates cogging, which can cause the system to shake.’

‘To overcome this problem iron-less core motors are made of copper 1. ‘windings’ that are wrapped around laminated steel embedded in epoxy resin. Iron-less core motors produce finer motion, but produce about only half that of an iron core motor.’ FIG. 5

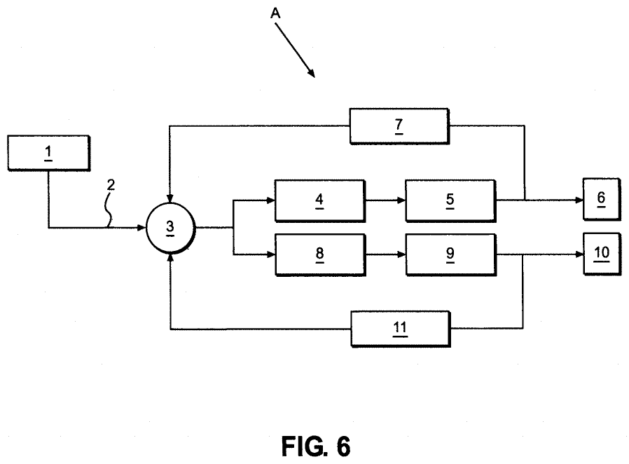

‘This iron-less tubular linear motor works with a 3 phase A/C power supply and motion controller. The linear motors primary part 1. ‘windings’ (coils) are connected to the power supply to produce a magnetic field. By changing the current phase in the 1. ‘windings’ (coils) the polarity of each coil is changed.’ FIG. 5 FIG. 6

The motion control system, controllers and drives (amplifiers), are used to synchronize the acceleration and de-acceleration of the Tubular linear motors in the Space Force Engine. FIG. 6

The motion control system, FIG. 6 also synchronizes the movement of the Tubular Linear Motor B. ‘backward force’ with the centripetal force requirements of the C. ‘Angular Momentum Engine’. FIG. 4

The 1. ‘computer’ contains the 2. ‘motion profile’ used in the 3. ‘programmable motion controller’ and its 4. ‘amplifier’ controls the 5. ‘Tubular Linear Motor’ 6. ‘motion and position’ is 7. ‘feedback’ to the 3. ‘motion controller’ to maintain the correct 2. ‘motion profile’ FIG. 6

The 1. ‘computer’ contains the 2. ‘motion profile’ used in the 3. ‘programmable motion controller’ and its 8. ‘amplifier’ controls the 9. ‘Angular Momentum Engine’ 10. ‘motion and position’ is 11. ‘feedback’ to the 3. ‘motion controller’ to maintain the correct 2. ‘motion profile’. Newer ‘intelligent drives can close the position and velocity loops internally resulting in much more accurate control. FIG. 6

‘A/C brushless technology delivers the highest accuracy and repeatability of any linear motor in the industry.’

The Angular Momentum Engines ‘real time’ environment in which it operate will dictate the magnitude of the centripetal forces required under ‘real time’ environmental conditions.

The C. ‘Angular Momentum Engine’ applies its ‘linear centripetal force’, created by angular momentum, to counteract the Tubular Linear Motors B. ‘backward force’. FIG. 4

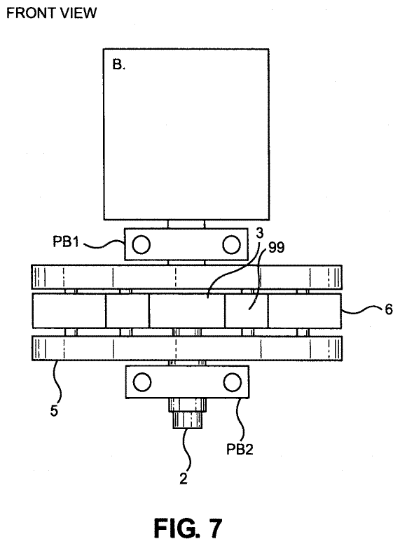

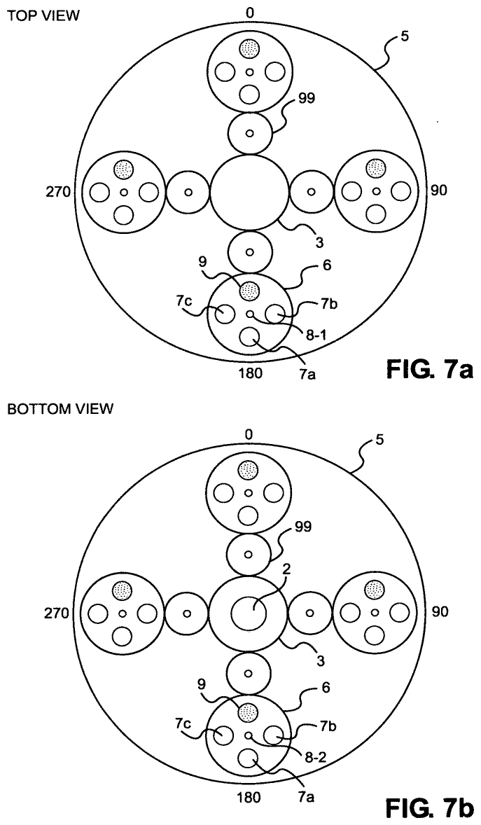

FIG. 7 This ‘Angular Momentum Engine’ uses a simple 1 stage planetary gearbox in its design. The 3. ‘sun gear’ and the 6. ‘planet gear’s have a 1:1 gear ratio. The 99. ‘pinion gear’s have a 2:1 gear ratio to the 3. ‘sun gear’ and the 6. ‘planet gear’s. The 3. ‘sun gear’ is held by the 2. ‘sun gear shaft’. The gearbox does not have a ring gear’. These gears have a double helical design and are oriented horizontally on their vertical axes.

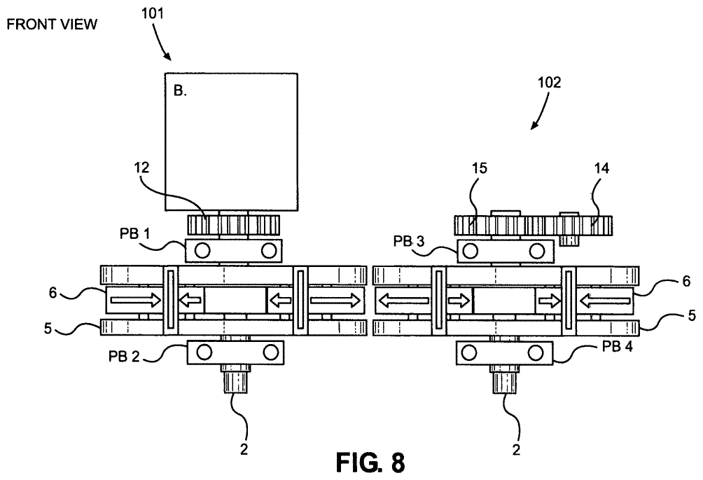

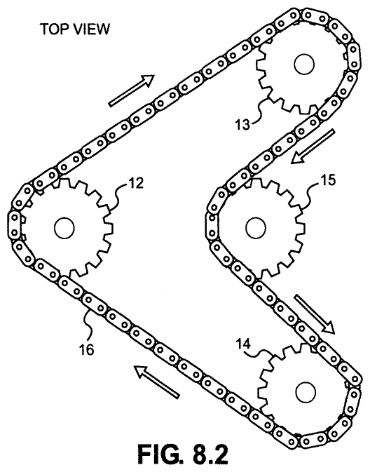

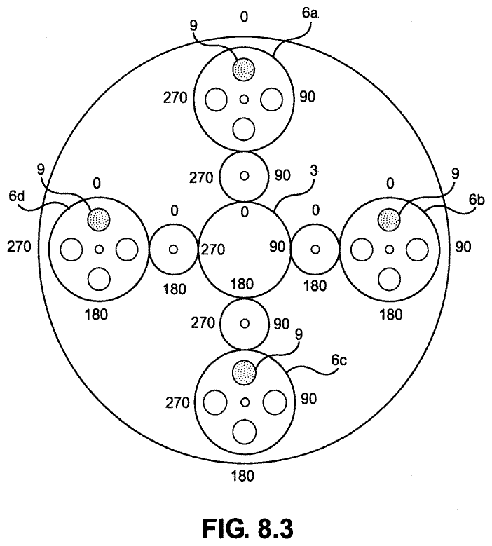

FIG. 7 FIG. 7a FIG. 7b This 1 stage planetary gearbox has a 5. ‘planet gear carrier’, four 99. ‘pinion gear’s, four 6. ‘planet gear’s and a one piece 3. ‘sun gear’ and 2. ‘sun gear shaft’ design. The 3. ‘sun gear’ is held by the 2. ‘sun gear shaft’. The 5. ‘planet gear carrier’ has an upper and lower flange. Each of the gears and flanges have a zero, ninety, one hundred eight, and two hundred seventy degree timing marks and are aligned on these timing marks. FIG. 8.3

The gearbox does not have a ring gear.

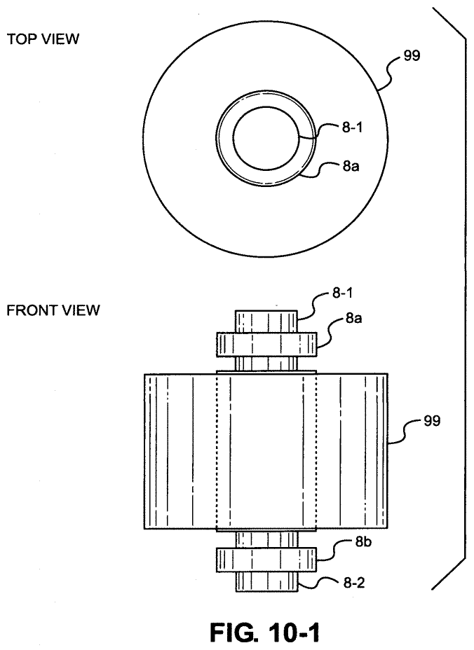

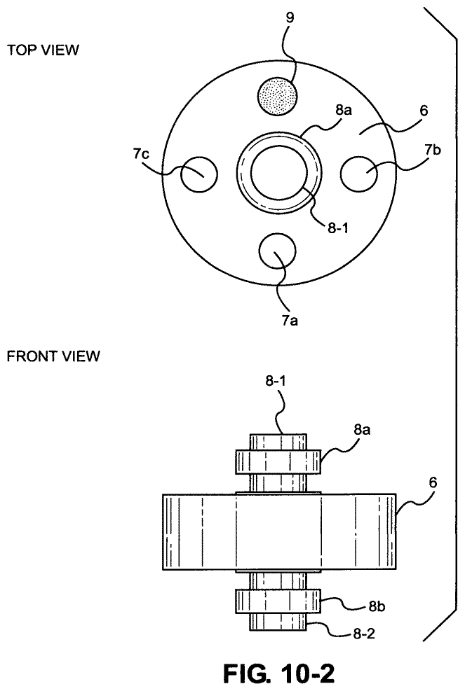

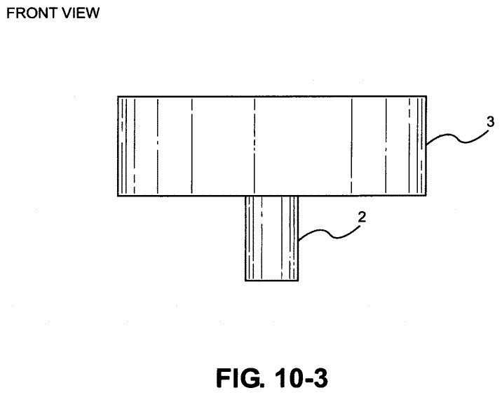

FIG. 10-2 illustrates the ‘one piece’ four inch diameter by 2 inch face width carbon steel 6. ‘planet gear’. Four lightening holes are machined into the carbon steel 6. ‘planet gear’, creating four ‘empty shells’. The one by two inch 7a. ‘empty shell’, 7b. ‘empty shell’, and 7e. ‘empty shell’ reduce the weight of the 6. ‘planet gear’ to improve ‘spin up time’.

FIG. 10-2 The 9. ‘tungsten-weight’ is a one by two inch tungsten round bar pressed into the empty shell. This tungsten 0.496 kg. (1.094 lb.) 9. ‘tungsten-weight’ is 2.4 times heavier than carbon steel. The 8-1. ‘planet gear axis’ uses the 8a. ‘bearing’. The 8-2. ‘planet gear axis’ uses the 8b. ‘bearing’.

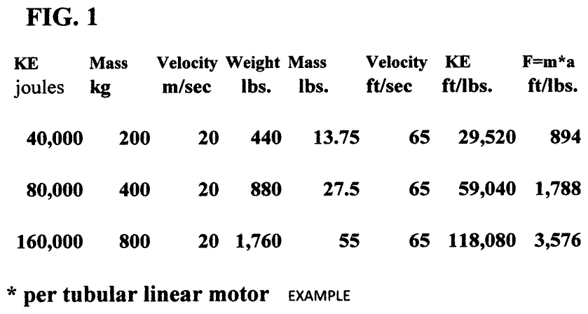

FIG. 10-1 illustrates the ‘one piece’ two inch diameter by 2 inch face width carbon steel 99. ‘pinion gear’. The 8-1. ‘pinion gear axis’ uses the 8a. ‘bearing’.

The 8-2. ‘pinion gear axis’ uses the 8b. ‘bearing’

FIG. 10-3 illustrates the ‘one piece’ four inch diameter by 2 inch face width carbon steel 3. ‘sun gear’. The 3. ‘sun gear’ is ‘held’ by the 2. ‘sun gear shaft’.

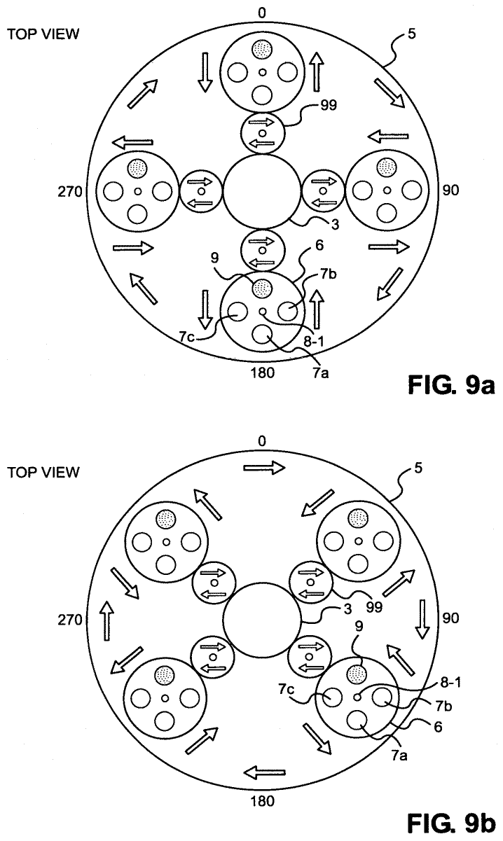

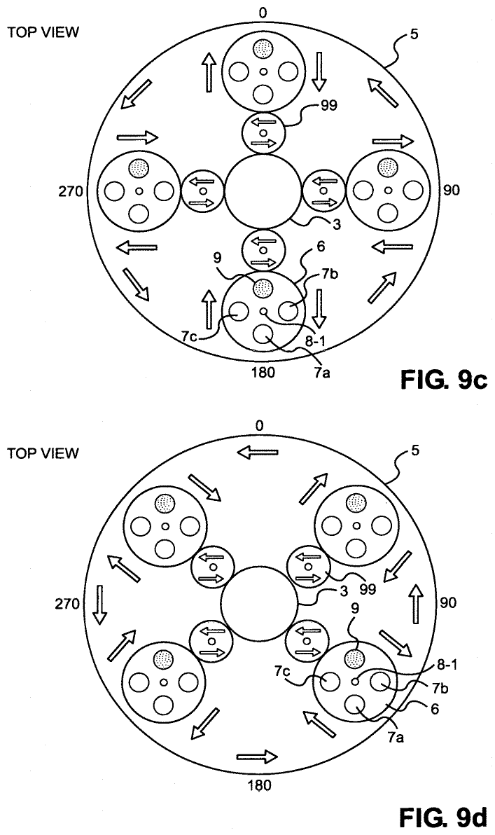

FIG. 7 FIG. 8 FIG. 9a, 9b, 9c, 9d The 101. ‘Planetary gearbox 1’, and 102. ‘Planetary gearbox 2’ turn clockwise and counter-clockwise, respectively, rotating their 5. ‘planet gear carrier’ assembly (99. ‘pinion gear’s and 6. ‘planet gear’s) around the held 3. ‘sun gear’. As the 6. ‘planet gear’s are rotated around the held 3. ‘sun gear’, a centripetal force is created on each 9. ‘tungsten-weight’ as a result of their angular momentum.

FIG. 7 FIG. 8 FIG. 9a, 9b, 9c, 9d The 6. ‘planet gear’s are simultaneously turned in the opposite direction on their ‘axis’ as a result of the held 3. ‘sun gear’ creating a second centripetal force on each 9. ‘tungsten-weight’ as a result of their angular momentum.

These two sets of ‘centripetal forces’ are examined further in this following detailed description.

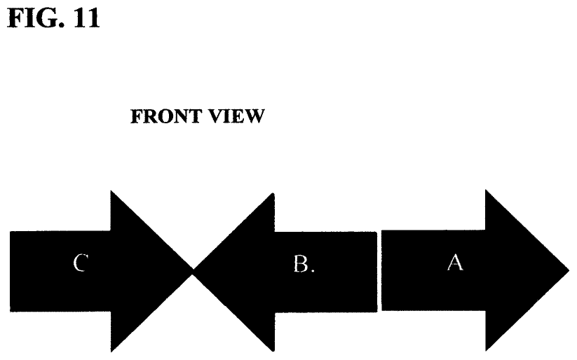

In this patent design, the relative motion of a tungsten-weight generates a linear centripetal force (see arrows) FIG. 11. that is applied against the space vehicles B. ‘backward force’. FIG. 4

This Angular Momentum Engine uses two identical ‘side by side’, vertically oriented ‘one stage’ planetary gearboxes. FIG. 8

The two identical ‘side by side’ gearboxes 101. ‘Planetary Gearbox 1’ and 102. ‘Planetary Gearbox 2’ rotate in opposite directions to balance the rotational forces. FIG. 8

FIG. 7 FIG. 8 FIG. 9a FIG. 9b The B. ‘3 phase induction Motor’ rotates the 101. ‘Planetary gearbox 1’ 45 degrees clockwise around the held 3. ‘sun gear’.

FIG. 7 FIG. 8 FIG. 9a FIG. 9b With the 3. ‘sun gear’ held, the 99. ‘pinion’ gear's turn 90 degrees clockwise and the 6. ‘planet gear’s turn 45 degrees counter-clockwise.

In summary. the 5. ‘planet gear carrier’ has rotated 45 degrees clockwise around the held 3. ‘sun gear’, while the 99. ‘pinion’ gears turn 90 degrees clockwise and the 6. ‘planet gear’s turn 45 degrees counter-clockwise on their axis in 101. ‘planetary gearbox 1’.

FIG. 8 FIG. 9c FIG. 9d The 102. ‘planetary gearbox 2’ turns in the opposite direction of 101. ‘planetary gearbox 1’ due to 12. ‘drive sprocket’, 15. ‘driven sprocket’ the 13. ‘idler sprocket’ and, 14. ‘idler sprocket’ and the 16. ‘double duplex timing chain’ reversing the rotational direction of the input to 102. ‘Planetary Gearbox 2’. FIG. 8.2

With the 15. ‘driven sprocket’ turning 45 degrees counter-clockwise the 5. ‘planet gear carrier’ assembly (99. ‘pinion gear’s and 6. ‘planet gear’s) rotates 45 degrees counter-clockwise around the held 3. ‘sun gear’. FIG. 8 FIG. 9c FIG. 9d

FIG. 8 FIG. 9c FIG. 9d With the 3. ‘sun gear’ held, the 99. ‘pinion’ gears turn 90 degrees counter-clockwise and the 6. ‘planet gear’s turn 45 degrees clockwise on their axis.

In summary. the 5. ‘planet gear carrier’ has rotated 45 degrees counter-clockwise around the held 3. ‘sun gear’ while the 99. ‘pinion’ gears turn 90 degrees counter-clockwise and the 6. ‘planet gear’s turn 45 degrees clockwise on their axis in 102. ‘planetary gearbox 2’.

This 45 degree motion analogy is used to illustrate the movement of the component parts of this Angular Momentum Engine in slow motion.

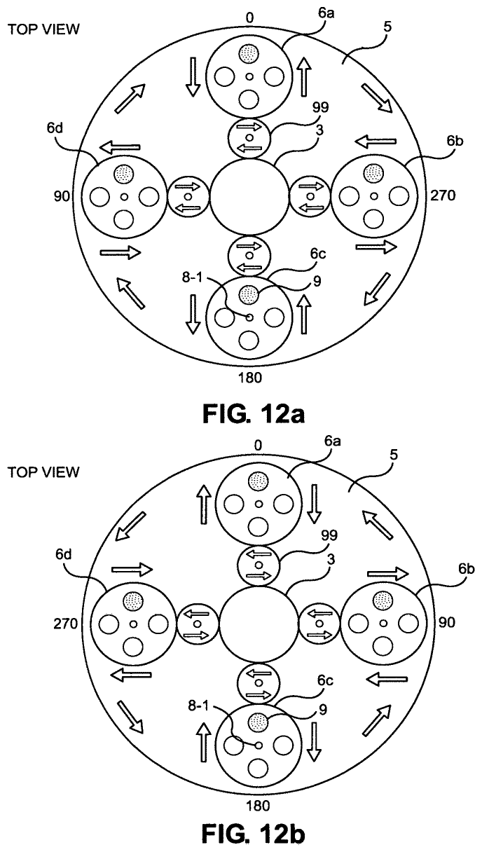

The ft/lbs. of linear centripetal force, for 101. planetary gearbox 1 is the sum of the clockwise rotation of the 6. ‘planet gear’s (6a, 6b, 6c, 6d). by the 5. ‘planet gear carrier’, and the counter-clockwise turning of the ‘planet gears’ (6a, 6b, 6c, 6d). as a result of the ‘held’ 3. ‘sun gear’. FIG. 12a

The ft/lbs. of linear centripetal force, for 102. ‘planetary gearbox 2’ is the sum of the counter-clockwise rotation of the 6. ‘planet gear’s (6a, 6b, 6c, 6d). by the 5. ‘planet gear carrier and the clockwise turning of the ‘planet gears’ (6a, 6b, 6c, 6d). as a result of the ‘held’ 3. ‘sun gear’. FIG. 12b

In summary, 102. ‘Planetary Gearbox 2’ runs in the opposite direction of the 101. ‘Planetary Gearbox 1’ each producing the following ft/lbs of linear centripetal force.

| Planetary gearbox 1 | Planetary gearbox 2 | Total | |
|---|---|---|---|
| 230.5 ft/lbs. @ 1000 | 230.5 ft/lbs. @ 1000 | 461 | ft/lbs. |
| rpm | rpm | | |
| 922 ft/lbs. @ 2000 | 922 ft/lbs. @ 2000 | 1,844 | ft/lbs. |
| rpm | rpm | | |
| 3,688 ft/lbs. @ 4000 | 3,688 ft/lbs. @ 4000 | 7,376 | ft/lbs. |
| rpm | rpm | | |
| 14,752 ft/lbs. @ 8000 | 14,752 ft/lbs. @ 8000 | 29,504 | ft/lbs. |
| rpm | rpm | | |
| 59,008 ft/lbs. @ 16000 | 59,008 ft/lbs. @ 16000 | 118,016\grave{ } | ft/lbs. |
| rpm | rpm | | |

Increasing the speed of rotation, from 1,000 to 16,000 rpm increases the linear centripetal force in proportion to the square of the speed, or 16 squared. The linear centripetal force is 256 times greater for this ‘angular momentum engine’ at 16,000 rpm (118,016 ft/lbs) than at 1000 rpm (461 ft/lbs). Increasing the tungsten weight by four, from 1.094 to 4.376 pounds would produce 472,064 ft/lbs of centripetal force @ 16,000 rpm.

A refined explanation of how the linear centripetal forces are created for each of the two planetary gearboxes follows.

The 1.094 lb. ‘tungsten-weight’(0.496 kg) on ‘planet gears’ 1 thru 4 (6a, 6b, 6c, 6d) in 101. ‘planetary gearbox 1’ and 102. ‘planetary gearbox 2’ are 1.25 inches away from its axis, FIG. 12a FIG. 12b

The 1,094 lb. tungsten-weight (0.496 kg) on 6a. ‘planet—1’ in 101. ‘planetary gearbox 1’ and 102. ‘planetary gearbox 2’ are 7.25 inches away from the 3. ‘sun gear’. FIG. 12a FIG. 12b

The 1.094 lb. ‘tungsten-weight’(0.49 kg) on 6c. ‘planet—3’ in 101. ‘planetary gearbox 1’ and 102. ‘planetary gearbox 2’ are minus 4.75 inches from the 3. ‘sun gear’. FIG. 12a FIG. 12b

In summary, centripetal force is a product of the (mass×velocity squared/radius).

The linear centripetal force for each of the planet gears (6a, 6b, 6c, 6d) ‘tungsten-weight’ change as they rotate around the 3. ‘sun gear’. The net sum of these forces, however, remains the same. FIG. 12a FIG. 12b

This Space Force Engine is a mechanical propulsion system that provides a thrust force only limited by the number and force of each engine(s) incorporated in the system. Its nuclear reactors and solar power supply the electric power to the Space Force Engine. Its novel design differs from the propeller, turbine (jet engine), ramjet, rocket propulsion. The A. ‘forward force’ is applied after the C. ‘Angular Momentum Motor’ counteracts the B. ‘backward force’ of the Tubular Linear Motor. FIG. 11

1. A Space Force Engine that reaches warp speeds in deep space comprising:
(a) An ironless Tubular Linear Motor member having windings, flux, magnets, current, a thrust force, and a movable rod
(b) An Angular Momentum Engine member that produces linear centripetal forces proportional to the square of the speed
(c) A motion control ‘on/off’ centripetal switch member
(d) A motion control member having a computer, motion profile, programmable motion controller, amplifier (drive), motion and position feedback
(e) A net force resistance member, includes the net forces of inertia, gravity, drag and other friction forces, backward forces, and other forces that oppose a physical object's change in velocity.

2) A Space Force Engine as claimed in claim 1, wherein:
(a) said Tubular Linear Motor member accelerates and then de-accelerates the said movable rod in one direction and then accelerates and de-accelerates the said movable rod in the opposite direction
(b) said Tubular Linear Motor member equal and opposite reaction from the said de-acceleration and said acceleration of the said movable rod results in a forward force
(c) said Tubular Linear Motor member equal and opposite reaction from the said de-acceleration and said acceleration of the said movable rod in the said opposite direction results in a backward force
(d) said Tubular Linear Motor member said movable rod time can be faster and the distance shorter to de-accelerate and accelerate the said movable rod in said backward force over said forward force to maximize said forward force said acceleration time and distance
(e) said Tubular Linear Motor member is a Lorentz-type motor in which the applied force is linearly proportional to the current and the magnetic field
(f) said Angular Momentum Engine member said linear centripetal forces counteracts the said Tubular Linear Motors member said backward force. The Tubular Linear Motor member said forward force then accelerates the space vehicle.

3) A Space Force Engine as claimed in claim 1, wherein:
(a) said motion control ‘on/off’ centripetal switch member is ‘on’ when the said centripetal forces are below or equal to the space vehicles said net force resistance member
(b) said motion control ‘on/off’ centripetal switch member is ‘off’ when the said centripetal forces are greater than the space vehicles said net force resistance member.

4) A Space Force Engine as claimed in claim 1, wherein:
(a) the said centripetal forces are applied to the said Tubular Linear Motor said backward force
(b) The said centripetal forces are applied to a space vehicles said net force resistance
(c) The centripetal force as claimed in claim 1, when greater than the space vehicles said net force resistance become tangential
(d) The centripetal force as claimed in claim 1, is used to maintain the current velocity of the space vehicle by counteracting the said net force resistance
(e) The motion control member said motion profile controls the motion and position of the said Tubular Linear Motor and the said Angular Momentum Engine
(f) The motion control ‘on/off’ centripetal switch member when ‘off’ the centripetal force is above the said net force resistance and becomes tangential
(g) The motion control ‘on/off’ centripetal switch member is ‘on’ when the centripetal force is below or equal to the said net force resistance.

5) A Space Force Engine as claimed in claim 1, wherein:
(a) The Angular Momentum Engine member as claimed in claim 1, requires the industries motion control motor, motion control system to regulate the centripetal force applied to the vehicles said net force resistance in a real time environment
(b) The Angular Momentum Engine member as claimed in claim 1, ‘real time’ environment in which it operates will dictate the magnitude of the centripetal forces required under real time’ environmental conditions
(c) The Angular Momentum Engine member as claimed in claim 1, wherein: said linear centripetal force is proportional to the square of the speed
(d) The Angular Momentum Engine as claimed in claim 1, starting position is at the three hundred and fifteen degree timing mark on said carrier for said planetary gearbox (1) and the forty five degree timing mark on said carrier for said planetary gearbox (2).
